(19) United States
(12) Patent Application Publication
(10) Pub. No.: US 2006/0044220 A1
(43) Pub. Date: Mar. 2, 2006

(54) Circuit for driving a display panel

(76) Inventor: Roy Van Dijk, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/533,719

(22) PCT Filed: Oct. 14, 2003
(86) PCT No.: PCT/IB03/04561

§ 371 Date: May 3, 2005

(30) Foreign Application Priority Data
Nov. 8, 2002 (EP) 02079680.1

(51) Int. Cl. G09G 3/20; G09G 5/02

(52) U.S. Cl. 345/55; 345/698

(57) ABSTRACT

A circuit for driving a display panel (3) that comprises a matrix of pixels (Pᵢⱼ), which matrix comprises the plurality of rows (i) and columns (j), which circuit comprises; a) an input for receiving an input signal (V1) comprising pixel values (sᵢⱼ) for the plurality of rows (i) in a frame to be displayed by at least some of the pixels (Pᵢⱼ), each pixel value (sᵢⱼ) determining a light output of a pixel (Pᵢⱼ), b) a memory (9) for storing the received pixel values (sᵢⱼ), c) processing circuitry (10) for analysing the pixel values (sᵢⱼ) in each of the plurality of rows (i) and for generating a row timing signal (Hsync2) for addressing a subset of the plurality of rows (i) for substantially a duration of a row time (trow2(i)), and d) a video output for supplying an output signal (V2) comprising output pixel values to pixels (Pᵢⱼ) in the subset of rows (i) being addressed. The processing circuitry (10) is arranged to determine each row time (trow2(i)) in dependence on at least one pixel value (sᵢⱼ) from among the pixel values (sᵢⱼ) for the subset of rows (i) being addressed during that row time (trow2(i)).

The invention relates to a circuit for driving a display panel that comprises a matrix of pixels, which matrix comprises a plurality of rows and columns.

The invention further relates to a display device, comprising a display panel that comprises a matrix of pixels, which matrix comprises a plurality of rows and columns, wherein the display device further comprises such a circuit.

The invention also relates to a method of driving a display panel that comprises a matrix of pixels, which matrix comprises a plurality of rows and columns.

Embodiments of such a circuit, method and display panel are known from U.S. Pat. No. 6,121,941. The known matrix display displays a video signal comprising active portions corresponding to picture information and inactive portions. The driving, so also the triggering, the control, of picture elements is carried out line by line. The clock frequency for triggering signal processing circuitry which controls the matrix display is reduced by extending the period of time for performing the signal processing algorithms by periods of time in which a video signal transmitted from a transmitter or a means of storage contains no picture information.

In the known circuit device and method, the light output of a pixel in a certain row can only be increased by providing more drive, for example, by providing a larger voltage, to the light-emitting elements of the pixels in that row, which may shorten the lifetime of the pixels in, for example, Light Emitting Diode displays. It is a disadvantage that the light output is limited to prevent a shortened lifetime.

It is a first object of the invention to provide a circuit of the kind described in the opening paragraph which is able to generate an increased light output from a pixel when displaying an image.

The first object is achieved by providing a circuit for driving a display panel that comprises a matrix of pixels, the matrix comprising a plurality of rows and columns, the circuit comprising:
an input for receiving an input signal comprising pixel values for the plurality of rows in a frame to be displayed by at least some of the pixels, each pixel value determining a light output of a pixel;
a memory for storing the received pixel values;
processing circuitry for analysing the pixel values in each of the plurality of rows and for generating a row timing signal for addressing a subset of the plurality of rows for substantially a duration of a row time being a time period for addressing a row, and
a video output for supplying an output signal comprising output pixel values to pixels in the subset of rows being addressed,
   wherein the processing circuitry is arranged to determine each row time in dependence on at least one pixel value from among the pixel values for the subset of rows being addressed during that row time.

Each subset may comprise a single row, or a plurality of rows that are simultaneously addressed, and of which the pixels are thus driven simultaneously. In general, the term frame is used to denote one image of a sequence of images. In an interlaced display panel, however, the invention can also be applied to, for example, an odd field or an even field, wherein one image is displayed by consecutively displaying the odd and even field. More in general, the term frame is used to denote one complete image, while the term field refers to a part of the frame.

By making the row time for the row or rows in each subset depend on the pixel values for that subset, the circuitry enables longer row times to be used for a subset wherein a high pixel value has to be displayed. This leads to an increase in light output for pixels in that subset, because the light output that is perceived increases with the time during which it emits light.

It is noted that U.S. Pat. No. 6,057,809 discloses a circuit that converts a stream of pixel values from a cathode-ray tube (CRT) format to a flat-panel, liquid crystal display (LCD), format. Four frames of LCD pixels are generated for each CRT frame. Frame rate cycling (FRC) is used to generate gray scales within these multiple frames by turning pixels on and off over the multiple frames in an FRC cycle that are generated from one CRT frame. A modulated line-pulse generator is coupled to the flat-panel display by a line-pulse signal. It generates a line pulse at an end of a horizontal line of pixels sent to the flat-panel display. The line pulse has a modulated time period that varies for different horizontal lines. A modulation pattern is stored in a register containing four values. A multiplexer selects a different one of the four values in turn over the cycle. Any row has the same total ‘on’ time for every cycle of four LCD frames, due to the repeating modulation pattern.

In this known circuit, the row time for a row does not depend on at least one pixel value in that row, but on the value stored in the register. Furthermore, the sub-signal provided in each column determines the intensity of a pixel only in the sense that it turns a pixel in that column on or off. The maximum intensity for displaying a pixel in the CRT frame is thus fixed, as the maximum total ‘on’ time for every cycle of LCD frames is fixed, and the driving signal can only have value 1 or 0, i.e. be on or off. This known circuit relies on the fact that an intrinsic memory effect is present in a pixel, so that the information is still present in the display when light is being made. Other types of display, such as Light Emitting Diode displays and Field Emission displays do not have such an intrinsic memory effect.

In an embodiment of the invention, the processing circuitry is arranged to determine the row times such that all subsets of the rows in a frame are addressed within a frame time, being a time period for addressing the plurality of rows in the frame, and that the frame time remains substantially constant over a number of consecutive frames.

The light output is therefore increased without varying the frame rate. This simplifies the circuit, since only one frame at a time needs to be analysed, and consequently stored during analysis.

Favorably, the circuitry is arranged to determine the value of each row time in dependence on a maximum value from among the pixel values for the subset of rows being addressed during that row time.

In this way the highest possible increase in light output is achieved. The time available for displaying a frame can be divided over the rows according to the maximum pixel values in each row, such that, in each row or subset of concurrently addressed rows, the pixel with the maximum pixel value is on for the entire row time for that row.

In a preferred embodiment the circuit is arranged to supply via the video output the output pixel values in the form of a pulse-width modulated signal. The processing circuitry may comprise a sub-circuit for generating a clock signal, having a clock period, each pulse width in the pulse-width modulated signal being a number of the clock periods, wherein the circuitry is arranged to determine the clock period for each frame by dividing the frame time by a sum of the maximum pixel values.

Thus, translating the pixel values of the input signal into output pixel values for each of the sub-signals is avoided. It is sufficient to generate sub-signals for consecutively addressing each row, the subsignals carrying information about the respective row times, and to generate the clock signal, having the clock period determined for the frame concerned. The number of clock periods during which each pixel is on, is the same for the input signal as for the output signal. The clock period itself is different from the one on the basis of which the pixel values were originally determined. The number of clock periods during which a row is addressed is also different and varies according to the row being addressed.

It is a second object of the invention to provide a display device of the kind described in the opening paragraph, which is able to display an image with an increased light output of a pixel.

The second object is thereby realised in that the display device comprises a display panel that comprises a matrix of pixels, which matrix comprises a plurality of rows and columns, wherein a circuit according to the invention is present.

The display device has the advantage of having a higher light output. In addition, this may be achieved by increasing the time a pixel is on, and not by increasing the driving voltage or current. For most types of display panels, this will lead to an increase in the lifetime of the display panel.

It is a third object of the invention to provide a method of the kind described in the opening paragraph which is able to generate an increased light output from a pixel when displaying an image.

The third object is thereby realised that the method of driving a display panel that comprises a matrix of pixels, which matrix comprises a plurality of rows and columns, comprises:
receiving an input signal comprising pixel values for the plurality of rows in a frame to be displayed by at least some of the pixels, each pixel value determining a light output of a pixel,
storing the received pixel values in a memory,
analyzing the pixel values in each of the plurality of rows,
generating a row timing signal for addressing a subset of the plurality of rows for substantially a duration of a row time being a time period for addressing a row, and
supplying an output signal comprising output pixel values, to pixels in the subset of rows being addressed,
   wherein, during analyzing the pixel value(s) in each of the plurality of rows, each row time is determined in dependence on at least one pixel value from among the pixel values for the subset of rows being addressed during that row time.

The method according to the invention has the advantage that it is possible to increase the light output in the frame. A row for which a high pixel value is received with the input signal will be addressed for a longer time than another row. It is thus possible to increase the light output emitted by the corresponding pixel in the row that is perceived by the beholder, relative to the light output emitted by pixels in other rows that are not concurrently addressed.

The invention is defined by the independent claims. The dependent claims define advantageous embodiments.

These and other aspects of the invention will be apparent from and elucidated with reference to the drawings, in which:

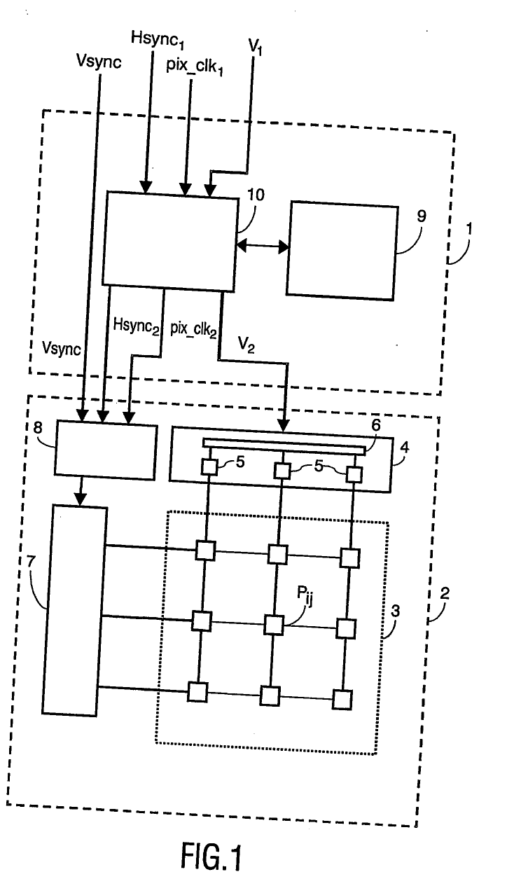

FIG. 1 is a schematic diagram, illustrating some components of a display device according to the invention;

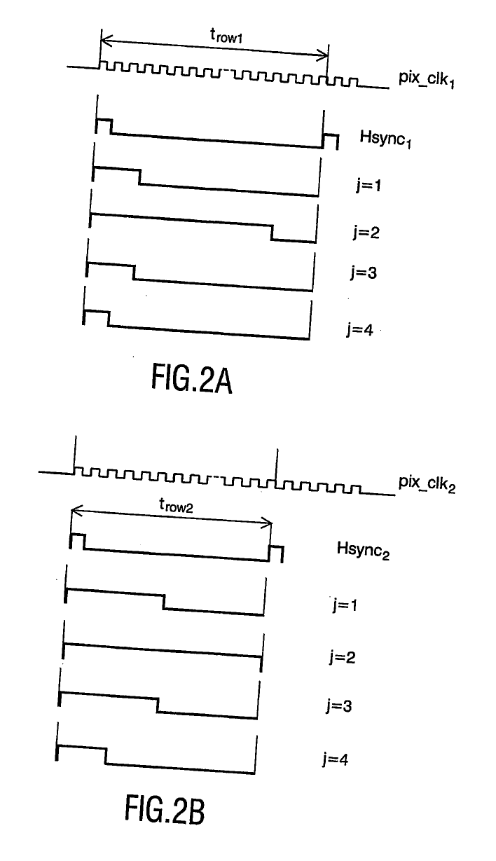

FIG. 2A is a diagram of the input signals supplied to an embodiment of the circuit according to the invention; and

FIG. 2B is a diagram of the output signals generated by an embodiment of the circuit according to the invention.

The invention provides a circuit for use in driving display devices incorporating a panel that is driven line by line. In such a display, picture elements, also called pixels, in a line, also called a row, are all driven concurrently, and each row is driven in turn. Thus, a plurality of sub-signals, equal to the number of columns in the display panel, i.e. the number of pixels in a row is concurrently applied to the panel. A selection signal determines the order in which rows of pixels are to be driven by the sub-signals. Examples of display panels which can be driven in such a way include polymer-Light Emitting Diode (polyLED) displays, electroluminescent displays, vacuum fluorescent displays and field emission displays. Further, this circuit may be applied in any other display panel for direct view or projection display that is addressed line-at-a-time and of which the pixels emit light during the addressing.

FIG. 1 is a schematic diagram in which a driver circuit 1 according to the invention is depicted, connected to a display device 2. In many embodiments of the invention, the driver circuit 1, will actually be part of the display device 2, but the present example is meant to show that this need not be the case. For example, the driver circuit 1 can be part of a graphics card, driving an external display device 2. The display device 2 incorporates a display panel 3. The display panel 3 is a matrix display panel, with rows and columns of light generating pixels. A pixel Pᵢⱼ is a member of one column and one row. Here, i denotes the row number, j denotes the column number. In this description it will be assumed that there are n columns and m rows. It is noted that the identification of rows and columns does not bear any relation to the orientation of the display panel 3 when in use. The rows can, for example, be horizontal or vertical in use.

The picture on the display panel 3 is built up row by row. The display device 2 comprises a data driver 4, comprising as many output stages 5 as there are columns, i.e. n. The data driver 4 in this example receives a composite output video signal V₂ comprising n sub-signals, one for each column. A serial to parallel converter 6 demultiplexes the composite output video signal V₂ to retrieve n sub-signals, one for each column, which it makes available to the output stages 5. Embodiments in which the composite output video signal V₂ actually comprises n sub-signals that are supplied to the display device 2 in parallel over separate data lines are also possible. The serial to parallel converter 6 is then not necessary. A select driver 7 determines which row is to be addressed by data driver 4, under the control of a timing control circuit 8. The timing control circuit 8 receives three timing signals, namely a vertical synchronisation signal Vsync, an output horizontal synchronisation signal Hsync₂, and an output pixel clock signal pix_clk₂ from the driver circuit 1. These signals enable the timing control circuit 8 to determine when to select which row.

In this embodiment, the data for one frame comprise m×n pixel values. For simplicity, this description will assume that the display device 2 and composite output video signal V₂ are adapted to progressive scanning. This means that the frame is built up row by row, sequentially. An embodiment in which interlacing is used is, however, within the scope of the invention. In such an embodiment, for example, the odd numbered rows are first addressed in turn, and the even numbered rows are subsequently addressed in turn.

This description will further assume that there is only one data driver 4 and select driver 7, and consequently that the composite output video signal V₂ comprises pixel values for one entire frame of m×n pixels Pᵢⱼ. The display may be a color display comprising, for example, red, green and blue color sub-pixels. These red, green and blue color sub-pixels may be located adjacent to each other in a repetitive pattern in row direction, wherein each of the color sub-pixels in a row is connected to an output stage 5 of the data driver 4. The invention works equally well for a display with such rows comprising color sub-pixels as well as for monochrome displays. Therefor, to simplify the elucidation, embodiments based on monochrome displays will be described. Other embodiments of the invention are possible in which there are several video signals, each comprising pixel values for pixels Pᵢⱼ, forming a part of a frame, and wherein there are a number of select drivers and data drivers operating concurrently.

It is noted that a related embodiment is conceivable in which a subset of rows, usually two, can be scanned at the same time (multi scan), with all the rows in a subset being addressed at the same time. As an example of this embodiment, consider a dual scan display panel. Such a panel is divided into a part comprising one half of the rows and a part comprising the other half. Two sub-signals of the composite output video signal V₂ are concurrently applied to two corresponding column parts, one to a column j in the first part of the panel, one to a column j in the other part of the panel. A pair of rows, one in each half, is addressed at the same time. The output horizontal synchronisation signal Hsync₂ determines the row time for both rows, i.e. they can only be addressed synchronously. This description will not describe the multi scan variant of the invention in any great detail, as the skilled person will recognise that the inventive concept, as described hereinafter for an embodiment in which one row is addressed at a time, can easily be applied to the driving of a multi scan display panel.

The output horizontal synchronisation signal Hsync₂ determines for how long each row is addressed. It consists of a series of pulses, each pulse signalling to the timing control circuit 8 that the select driver 7 should be instructed to select a next row. It is observed that some display devices may address each row for only part of the interval between pulses in the output horizontal synchronization signal Hsync₂, leaving the rest as a horizontal blanking interval. The time between two consecutive pulses shall be referred to as the output row time t_{row2}. The vertical synchronization signal Vsync also comprises a number of pulses. Here, the time between two consecutive pulses shall be referred to as the frame time t_{f}. In a preferred embodiment of the invention, the sum of the row times for all of the rows in a frame equals the frame time t_{f}. However, embodiments are possible, in which this sum is smaller. The difference constitutes a virtual blanking interval. Each pulse in the vertical synchronization signal Vsync signals to the timing control circuit 8 that the select driver 7 should be instructed to select the first row in the display panel 3, in order to start building up a new frame.

The sub-signals in the composite output video signal V₂ comprise discrete pixel values between 0 and a maximum value, for example 256. The values indicate the number of clock pulses in the output pixel clock signal pix_clk₂ during which a pixel should be driven, i.e. emit light. Thus, the signals supplied by the output stages 5 to the display panel 3 are pulse width modulated, with the values of the sub-signals of the composite output video signal V₂ determining the width of the pulse. In a current-driven display panel 3, for example a polyLED display panel, the output stages 5 supply a pulse width modulated current, in a voltage-driven display panel 3, the output stages 5 supply a pulse width modulated voltage. The invention can be used in either situation.

An embodiment of the invention is possible in which the signals supplied by the output stages 5 to the display panel 3 are also amplitude modulated. In this case, the composite output video signal V₂ can also comprise a sub-signal determining the level at which each pixel should be driven, or a number of sub-signals determining this level for each column separately.

In FIG. 1, the driver circuit 1 accepts as input signal a composite input video signal V₁, an input horizontal synchronization signal Hsync₁, the vertical synchronization signal Vsync, and an input pixel clock signal pix_clk₁ The composite input video signal V₁ comprises pixel values, i.e. intensity values for individual pixels. It comprises a number of sub-signals, each determining pixel values for a particular column. The composite input video signal V₁ can be a multiplex of the sub-signals, or it can be provided in the form of a plurality of individual signals on separate data lines. What has been written above for the composite output video signal V₂, output horizontal synchronization signal Hsync₂, and output pixel clock signal pix_clk₂ applies equally to the composite input video signal V₁, input horizontal synchronization signal Hsync₁ and input pixel clock signal pix_clk₁. This description will assume that the driver circuit 1 processes the data comprised in composite input video signal V₁ one fame at a time.

As is the case for the composite input video signal V₁, the sub-signals in the composite output video signal V₂ comprise discrete values between 0 and a maximum value, for example 256. In contrast to the output horizontal synchronization signal Hsync₂, however, the row time determined by input horizontal synchronization signal Hsync₁, referred to as input row time t_{row1}, is constant, for example equal to 256 clock pulses. Thus, if the input signals to the driver circuit 1 were to be provided to the display device 2 directly, the maximum time during which an output stage 5 can drive a pixel would be fixed. The driver circuit 1 according to the invention, however, allows the maximum row time to be increased, thus enabling certain pixels to be driven for a longer time than the row time determined by the input horizontal synchronization signal Hsync₁.

For this purpose, the driver circuit 1 comprises a frame buffer 9 and processing circuitry 10. An incoming frame of video data, comprised in composite input video signal V₁ is stored in the frame buffer 9 and analyzed by processing circuitry 10. The circuitry 10 then calculates new row times and a new pixel clock period, which are used to generate the output horizontal synchronization signal Hsync₂ and output pixel clock signal pix_clk₂.

Let us assume that a frame of video data comprises pixel values sᵢⱼ, each determining an intensity of emitted light for a pixel Pᵢⱼ in a matrix of pixels. A matrix, comprising m×n pixel values sᵢⱼ, is stored in frame buffer 9. The circuitry 10 determines the maximum pixel value in each row, thus determining a vector h, of which each element hᵢ is defined as:

$${h}_{i} = {max}_{j} {s}_{ij} , i = 1 … m . \qquad ( 1 )$$

Subsequently, the circuitry 10 determines the sum S of the maximum pixel values:

$$S = {\sum }_{i = 1}^{m} {h}_{i} . \qquad ( 2 )$$

Assuming that no virtual blanking interval is to be left over, the clock period t_clk₂ for the output pixel clock signal pix_clk₂ is calculated as:

$${t\_clk}_{2} = \frac{{t}_{f}}{S} . \qquad ( 3 )$$

Row times t_{row2}(i) are calculated for each row i, as:
t_{row2}(i)=t_{—}clk₂·hᵢ, i=1 . . . m (4)

From equation (4), it can be seen that the total frame time is divided over the rows in proportion to the maximum pixel value in the row.

It is observed that, if the display device 2 is of the multi-scan type, the vector h will contain the maximum pixel value of all the pixel values in a subset of rows that are concurrently addressed. Alternatively, for each part of the multi-scan display row times may be determined for each line. In that case for each part a set of output horizontal synchronization signals Hsync₂ is required. It is advantageous for each of the parts to use the same output pixel clock signal pix_clk₂ for a frame to ensure that the ratios of light output of each pixel within a frame remain in line with the ratios in the input composite video signal V₁.

For the same reason, if the display is driven in, for example, an interlaced manner, it is preferred to calculate the clock period t_clk₂ for an entire frame and use that clock period t_clk₂ for each of the fields within that frame.

Thus, the row with the highest maximum pixel value gets the longest row time. Of course, it would also have been possible to analyze a number of consecutive frames and to divide the total frame time for these frames over the row times for each frame. However, this results in a variable frame rate, which is noticeable to a viewer. Additionally, this would require several frame buffers 9.

The pixel with the maximum pixel value in a row is also driven for the full duration of the row time for that row. Thus, no time is “wasted”. By providing an output pixel clock signal pix_clk₂, with a different clock period than input pixel clock signal pix_clk₁, the pixel values in the frame buffer need not be re-calculated. They still indicate the number of clock pulses that a pixel should be driven, but because the duration of a clock pulse has now increased, the net effect is that pixels are driven longer.

As described so far, the invention exploits the frame time t_{f} to the fill, such that at any moment during display of the frame, at least one of the pixels in the subset of rows that are being addressed emits light. However, embodiments of the invention are conceivable in which some of the frame time is sacrificed, in effect creating a virtual blanking interval.

For example, to simplify the logic circuitry 10, for example to avoid having to handle floating point numbers, use can be made of look-up tables of possible clock periods. In this case, the logic circuitry 10 selects the value in the table that comes closest to the value according to equation (3), and that at the same time is lower than the calculated period.

Another embodiment has the advantage of avoiding rapidly changing clock frequencies between frames. In this embodiment, the driver circuit 1 is arranged to set the new clock period of the output pixel clock signal pix_clk₂ to a moving average of the values of the clock period t_clk₂, calculated over a number of consecutive frames. This means that the driver circuit 1 determines the clock period for a frame in the frame buffer 9, using equation (3). The new clock period of the output pixel clock signal pix_clk₂ is then set to an average of this clock period and a number of clock periods calculated for previous frames according to equation (3). When using such a smoothing filter, the sum of the row times for one frame can exceed the frame time t_{f}. This can be avoided, if desired, by subtracting a virtual blanking interval from the frame time and substituting the result for the frame time t_{f} in equation (3).

An advantage of the invention, is that it allows an increase in light output, without raising the amplitude of the signal supplied from the output stages 5 to the pixels Pᵢⱼ. The light output increases by increasing the pulse width of a pulse width modulated signal. Recall that a pulse width modulated signal is a signal wherein a value is determined by a pulse with a pulse width equal to a predetermined integer multiple of the clock periods t_clk₂. In another embodiment, the driver circuit 1 is arranged to generate one or more sub-signals determining the value of the amplitude of the signal to be supplied to a pixel. The one or more sub-signals determine the amplitude of the signal, i.e. the pulse height, whereby the pulse width may be kept constant for each pixel. Alternatively, a combination of pulse width and pulse height modulation may be applied. In this case, an increase in the allowable pulse width can be used for lowering of the maximum amplitude, thereby maintaining the same light output while lengthening the lifetime of the display panel 3. This feature can further be used to set the overall brightness for the entire frame, according to an adaptation algorithm. Preferably, the composite input video signal V₁ is processed according to such an adaptation algorithm, before being supplied to the driver circuit 1. The adaptation algorithm can take account of the adjustment of relative intensities made possible by the driver circuit 1 of the invention.

A simplified example will now be used to explain the invention further. Table 1 shows the pixel values for a (hypothetical) frame with three rows i=1,2,3 and four columns j=1,2,3,4. All values are on a scale from 0 to 256. FIG. 2A shows the input signals of the driver circuit 1: input pixel clock signal pix_clk₁, input horizontal synchronisation signal Hsync₁, and the values of the four sub-signals (one for each of the four columns) contained in the composite input video signal V₁, for the first row, i=1. It is assumed that the frame time t_{f} is 15 ms and the input row time t_{row1} 5 ms. The input row time t_{row1} equals 256 periods of input pixel clock signal pix_clk₁. The clock period is thus 0.02 ms. Note that the value for the input row time t_{row1} is much larger than in a realistic display device, due to the fact that the number of rows in this example has been greatly decreased to simplify the example.

TABLE 1

| | J = 1 | J = 2 | J = 3 | J = 4 |
|---|---|---|---|---|
| i = 1 | 51 | 205 | 51 | 26 |
| i = 2 | 179 | 77 | 230 | 128 |
| i = 3 | 154 | 77 | 102 | 256 |

The values in table 1 are stored in frame buffer 9. Using equation (1), logic circuitry 10 determines the maximum pixel value in each row, i.e. h=[205, 230, 256]. Then, the total of the maximum pixel values is determined, i.e. S=205+230+256=691. An output clock period time is determined as 15 ms/691=0.022 ms. Values of the output row time t_{row2} are calculated using equation (4), to equal 4.45, 4.99 and 5.56 ms, respectively.

FIG. 2B furthermore shows the output signals of the driver circuit 1, present in the columns j=1,2,3,4, for driving the first row, the output pixel clock pix_clk₂, having the period time of 0.022 ms and the output row time trow₂. Note that the output row time t_{row2} is now a smaller number of clock periods. The second pixel in the first row, P₁₂, driven via the second column j=2, is driven for the full duration of the row time t_{row2}(1) for that row.

The invention is not limited to the embodiments described above, which can be varied within the scope of the attached claims. For example, the driver circuit 1 can be an integrated part of a larger circuit that receives television signals in PAL, NTSC or SECAM format. In such an embodiment, the input horizontal synchronization signal Hsync₁, vertical synchronization signal Vsync and input video signal V₁ are first extracted from the television signals, before being processed in the manner described above.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. Circuit (1) for driving a display panel (3) that comprises a matrix of pixels (Pᵢⱼ), the matrix comprising a plurality of rows (i) and columns (j), the circuit comprising:
an input for receiving an input signal (V₁) comprising pixel values (sᵢⱼ) for the plurality of rows (i) in a frame to be displayed by at least some of the pixel (Pᵢⱼ), each pixel value (sᵢⱼ) determining a light output of a pixel (Pᵢⱼ);
a memory (9) for storing the received pixel values (sᵢⱼ);
processing circuitry (10) for analyzing the pixel values (sᵢⱼ) in each of the plurality of rows (i) and for generating a row timing signal (Hsync₂) for addressing a subset of the plurality of rows (i) for substantially a duration of a row time (t_{row2}(i)) being a time period for addressing a row, and
a video output for supplying an output signal (V₂) comprising output pixel values to pixels (Pᵢⱼ) in the subset of rows (i) being addressed,
wherein the processing circuitry (10) is arranged to determine each row time (t_{row2}(i)) in dependence on at least one pixel value (sᵢⱼ) from among the pixel values (sᵢⱼ) for the subset of rows (i) being addressed during that row time (t_{row2}(i)).

2. Circuit (1) according to claim 1, wherein the circuitry (10) is arranged to determine the row times (t_{row2}(i)) such that all of the subsets of rows (i) in a frame are addressed within a frame time (t_{f}), being a time period for addressing the plurality of rows (i) in the frame, and that the frame time (t_{f}) remains substantially constant over a number of consecutive frames.

3. Circuit (1) according to claim 1, wherein the circuitry (10) is arranged to determine the value of each row time (t_{row2}(i)) in dependence on a maximum value (hᵢ) from among the pixel values (sᵢⱼ) for the subset of rows being addressed during that row time t_{row2}(i)).

4. Circuit (1) according to claim 3, wherein the circuitry (10) is arranged to supply via the video output the output pixel values in the form of a pulse-width modulated signal.

5. Circuit (1) according to claim 4, the processing circuitry (10) comprising a sub-circuit for generating a clock signal (pix_clk₂) having a clock period, each pulse width in the pulse-width modulated signal being a number of the clock periods, wherein the circuitry (10) is arranged to determine the clock period for each frame by dividing the frame time (t_{f}) by a sum (S) of the maximum pixel values (hᵢ).

6. Circuit (1) according to claim 4, the circuitry (10) comprising a sub-circuit (10) for generating a clock signal (pix_clk₂) having a clock period, each pulse width in the pulse-width modulated signal being a number of the clock periods, and a look-up table of possible clock periods, wherein the circuitry (10) is arranged to determine the sum (S) of the maximum pixel values (hᵢ), and to select the clock period from the look-up table on the basis of the sum (S) calculated.

7. Circuit (I) according to claim 4, wherein the circuitry (10) comprises a sub-circuit for generating a clock signal (pix_clk₂) having a clock period, each pulse width in the pulse width modulated signal being a number of the clock periods, wherein the circuitry (10) is arranged to set the clock period of a frame to a value determined by averaging clock periods determined for a number of consecutive frames.

8. Circuit (1) according to claim 1, arranged to generate via the video output the output signal (V₂) corresponding to an amplitude of a signal to be supplied to a pixel (Pᵢⱼ).

9. Display device, comprising a display panel (3) that comprises a matrix of pixels (Pᵢⱼ), which matrix comprises a plurality of rows (i) and at least one column ( ), wherein the circuit (1) according to claim 1 is present.

10. Method of driving a display panel (3) that comprises a matrix of pixels (Pᵢⱼ), which matrix comprises a plurality of rows (i) and columns (j), the method comprising the steps of:
receiving an input signal (V₁) comprising pixel values (sᵢⱼ) for the plurality of rows (i) in a frame to be displayed by at least some of the pixels (Pᵢⱼ), each pixel value (sᵢⱼ) determining a light output of a pixel (Pᵢⱼ);
storing the received pixel values (sᵢⱼ) in a memory (9),
analyzing the pixel values (sᵢⱼ) in each of the plurality of rows (i);
generating a row timing signal (Hsync₂) for addressing a subset of the plurality of rows (i) for substantially a duration of a row time (t_{row2}(i)) being a time period for addressing a row; and
supplying an output signal (V₂) comprising output pixel values to pixels (Pᵢⱼ) in the subset of rows (i) being addressed,
wherein, during analyzing the pixel value(s) (sᵢⱼ) in each of the plurality of rows (i), each row time (t_{row2}(i)) is determined in dependence on at least one pixel value from among the pixel values for the subset of rows being addressed during that row time (t_{row2}(i)).
